(19) United States
(12) Patent Application Publication
(10) Pub. No.: US 2022/0067862 A1
(43) Pub. Date: Mar. 3, 2022

(54) METHOD, APPARATUS, AND COMPUTER PROGRAM PRODUCT FOR DYNAMIC POPULATION ESTIMATION

(71) Applicant: HERE Global B.V., Eindhoven (NL)

(72) Inventor: Xiang LIU, Berlin (DE)

(21) Appl. No.: 17/118,343

(22) Filed: Dec. 10, 2020

Related U.S. Application Data
(60) Provisional application No. 63/071,626, filed on Aug. 28, 2020.

(51) Int. Cl. G06Q 50/26; G06Q 30/02

(52) U.S. Cl. CPC G06Q 50/26; G06Q 30/0201

(57) ABSTRACT

Provided herein is a method, apparatus, and computer program product for estimating the dynamic population over a large area. Methods may include: receiving mobility data representing an observed population of a region; receiving population count data representing a count of the population of a first sub-region of the region, where the population count data is generated based on at least one sensor arranged to visually confirm and count the physical presence of people within the first sub-region; identifying the observed population of the first sub-region from the mobility data; determining a sampling rate based upon the observed population of the first sub-region and the count of the population of the first sub-region; and determining a population of a second sub-region of the region based on the sampling rate and mobility data representing the observed population of the second sub-region.

### CROSS-REFERENCE TO RELATED APPLICATIONS

This application claims priority to U.S. Provisional Application Ser. No. 63/071,626, filed on Aug. 28, 2020, the contents of which are hereby incorporated by reference in their entirety.

### TECHNOLOGICAL FIELD

Example embodiments described herein relate generally to estimate dynamic population over a large area, and more particularly, to using measured population data and mobility data to generate calibrated population estimations for which measured population data is not available.

### BACKGROUND

Population estimation for a region is difficult based on the unique behavior of individuals within a population and often unpredictable movement. Census data provides population estimates for a region; however, census data is generally periodic, static population counts. Thus, census data only provides a static snapshot of population information. Further, census data does not provide information regarding where people actually are and instead relies upon residential addresses to establish head counts.

Population data is valuable for a variety of reasons ranging from democratic representation of a population to identifying where people are in order to target advertising. Further, population data over time reveals migratory patterns of people through a region. More frequent population data that changes over shorter periods of time may further be useful for a variety of reasons, including the planning of roadways or public transit, among other uses.

### BRIEF SUMMARY OF EXAMPLE EMBODIMENTS

At least some example embodiments are directed to estimate dynamic population over a large area, and more particularly, to combining measured population data and mobility data to generate calibrated population estimation and extrapolating that calibrated population estimation across a broader area. Embodiments may provide an apparatus including at least one processor and at least one memory including computer program code, the at least one memory and the computer program code may be configured to, with the processor, cause the apparatus to at least: receive mobility data representing an observed population of a region; receive measured population count data representing a count of the population of a first sub-region of the region, where the population count data is generated based on at least one sensor arranged to visually confirm and count the physical presence of people within the first sub-region; identify the observed population of the first sub-region from the mobility data; determine a sampling rate based upon the observed population of the first sub-region and the count of the population of the first sub-region; and determine a population of a second sub-region of the region based on the sampling rate and mobility data representing the observed population of the second sub-region.

The mobility data of some embodiments includes location information for a plurality of mobile devices within the region. The sampling rate may be established for a first epoch based on a time and context of the mobility data and the population count data, where causing the apparatus to calculate the population of the second sub-region of the region based on the sampling rate and the mobility data representing the observed population of the second sub-region includes causing the apparatus to calculate the population of the second sub-region of the region for a second epoch based on the sampling rate and mobility data representing the observed population of the second sub-region for a time and context within a predefined similarity of the first epoch. The context may include context elements, where the context elements of a context include at least one of: a season, a day of week, a month of year, a weather condition, a point-of-interest type, and a type of zoning, where a predefined similarity of context includes correspondence of at least one context element between the first sub-region and the second sub-region.

The apparatus of example embodiments may be caused to: divide observed populations of each of a first plurality of sub-regions by a count of the population of a respective sub-region of the plurality of sub-regions to obtain a sampling rate for each of the first plurality of sub-regions; identify observed populations of a second plurality of sub-regions; and calculate a population of at least one of the second plurality of sub-regions based on the observed population of the at least one of the second plurality of sub-regions and a sampling rate from a sub-region of the first plurality of sub-regions having an observed population within a predetermined degree of similarity of the at least one of the second plurality of sub-regions. The apparatus may be configured to provide the population of the second sub-region to a service provider, where the service provider provides a service within the second sub-region based, at least in part, on the population of the second sub-region. The apparatus may be configured to provide the population of the second sub-region to a service provider, where the service provider provides a service within the second sub-region having a cost based, at least in part, on the population of the second sub-region.

Embodiments provided herein include a computer program product including at least one non-transitory computer-readable storage medium having computer-executable program code instructions stored therein, the computer-executable program code instructions including program code instructions to: receive mobility data representing an observed population of a region; receive population count data representing a count of the population of a first sub-region of the region, where the population count data is generated based on at least one sensor arranged to visually confirm and count the physical presence of people within the first sub-region; identify the observed population of the first sub-region from the mobility data; determine a sampling rate based upon the observed population of the first sub-region and the count of the population of the first sub-region; and determine a population of a second sub-region of the region based on the sampling rate and mobility data representing the observed population of the second sub-region.

According to some embodiments, the mobility data includes location information for a plurality of mobile devices within the region. The sampling rate may be established for a first epoch based on a time and context of the mobility data and the population count data, and the program code instructions to calculate the population of the second sub-region of the region based on the sampling rate and the mobility data representing the observed population of the second sub-region may include program code instructions to: calculate the population of the second sub-region of the region for a second epoch based on the sampling rate and mobility data representing the observed population of the second sub-region for a time and context within a predefined similarity of the first epoch. The context may include context elements, where the context elements include at least one of a season, a day of week, a month of year, a weather condition, a point-of-interest type, and a type of zoning, where a predefined similarity of context includes correspondence of at least one context element between the first sub-region and the second sub-region.

The computer program product of an example embodiment includes program code instructions to: divide observed populations of each of a first plurality of sub-regions by a count of the population of a respective sub-region of the first plurality of sub-regions to obtain a sampling rate for each of the first plurality of sub-regions; identify observed populations for a second plurality of sub-regions; and calculate a population of at least one of the second plurality of sub-regions based on the observed population of the at least one of the second plurality of sub-regions and a sampling rate from a sub-region of the first plurality of sub-regions having an observed population within a predefined degree of similarity of the at least one of the second plurality of sub-regions. Embodiments may include program code instructions to: provide the population of the second sub-region to a service provider, where the service provider provides a service within the second sub-region based, at least in part, on the population of the second sub-region. Embodiments may include program code instructions to provide the population of the second sub-region to a service provider, where the service provider provides a service within the second sub-region having a cost based, at least in part, on the population of the second sub-region.

Embodiments provided herein may include a method including: receiving mobility data representing an observed population of a region; receiving population count data representing a count of the population of a first sub-region of the region, where the population count data is generated based on at least one sensor arranged to visually confirm and count the physical presence of people within the first sub-region; identifying the observed population of the first sub-region from the mobility data; determining a sampling rate based upon the observed population of the first sub-region and the count of the population of the first sub-region; and determining a population of a second sub-region of the region based on the sampling rate and mobility data representing the observed population of the second sub-region.

The mobility data may include location information for a plurality of mobile devices within the region. The sampling rate may be established for a first epoch based on a time and context of the mobility data and the population count data, where calculating the population of the second sub-region of the region based on the sampling rate and the mobility data representing the observed population of the second sub-region includes calculating the population of the second sub-region of the region for a second epoch based on the sampling rate and mobility data representing the observed population of the second sub-region for a time and context within a predefined similarity of the first epoch.

According to some embodiments, the context may include context elements, where the context elements of a context include at least one of: a season, a day of week, a month of year, a weather condition, a point-of-interest type, and a type of zoning, where a predefined similarity of context may include correspondence of at least one context element between the first sub-region and the second sub-region. Methods may include: dividing observed populations of each of a first plurality of sub-regions by a count of the population of a respective sub-region of the first plurality of sub-regions to obtain a sampling rate for each of the plurality of sub-regions; identifying observed populations of a second plurality of sub-regions; and calculating a population of at least one of the second plurality of sub-regions based on the observed population of the at least one of the second plurality of sub-regions and a sampling rate from a sub-region of the first plurality of sub-regions having an observed population within a predetermined degree of similarity of the at least one of the second plurality of sub-regions. Methods may include providing the population of the second sub-region to a service provider, where the service provider provides a service within the second sub-region based, at least in part, on the population of the second sub-region.

Embodiments provided herein may include an apparatus including: means for receiving mobility data representing an observed population of a region; means for receiving population count data representing a count of the population of a first sub-region of the region, where the population count data is generated based on at least one sensor arranged to visually confirm and count the physical presence of people within the first sub-region; means for identifying the observed population of the first sub-region from the mobility data; means for determining a sampling rate based upon the observed population of the first sub-region and the count of the population of the first sub-region; and means for determining a population of a second sub-region of the region based on the sampling rate and mobility data representing the observed population of the second sub-region.

The mobility data may include location information for a plurality of mobile devices within the region. The sampling rate may be established for a first epoch based on a time and context of the mobility data and the population count data, where calculating the population of the second sub-region of the region based on the sampling rate and the mobility data representing the observed population of the second sub-region includes calculating the population of the second sub-region of the region for a second epoch based on the sampling rate and mobility data representing the observed population of the second sub-region for a time and context within a predefined similarity of the first epoch.

According to some embodiments, the context may include context elements, where the context elements of a context include at least one of: a season, a day of week, a month of year, a weather condition, a point-of-interest type, and a type of zoning, where a predefined similarity of context may include correspondence of at least one context element between the first sub-region and the second sub-region. An example apparatus may include: means for dividing observed populations of each of a first plurality of sub-regions by a count of the population of a respective sub-region of the first plurality of sub-regions to obtain a sampling rate for each of the plurality of sub-regions; means for identifying observed populations of a second plurality of sub-regions; and means for calculating a population of at least one of the second plurality of sub-regions based on the observed population of the at least one of the second plurality of sub-regions and a sampling rate from a sub-region of the first plurality of sub-regions having an observed population within a predetermined degree of similarity of the at least one of the second plurality of sub-regions. An apparatus may include means for providing the population of the second sub-region to a service provider, where the service provider provides a service within the second sub-region based, at least in part, on the population of the second sub-region.

### BRIEF DESCRIPTION OF THE DRAWINGS

Having thus described certain example embodiments in general terms, reference will hereinafter be made to the accompanying drawings, which are not necessarily drawn to scale, and wherein:

FIG. 1 is a block diagram showing an example architecture of an example embodiment described herein;

FIG. 2 is a block diagram of an apparatus that may be specifically configured in accordance with an example embodiment of the present disclosure;

FIG. 3 illustrates a bock diagram of gathering dynamic mobility data within a geographic region according to an example embodiment of the present disclosure;

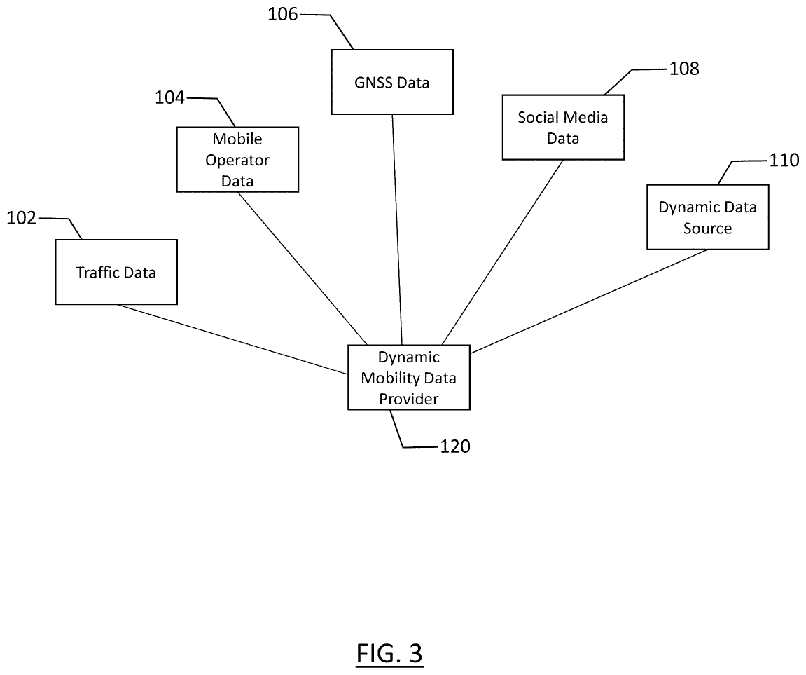

FIG. 4 illustrates a flowchart for dynamic population estimation according to an example embodiment of the present disclosure;

FIG. 5 illustrates the user interface heat map of dynamic population estimates according to an example embodiment of the present disclosure; and

FIG. 6 is a flowchart of a method for establishing the dynamic population estimate for a geographic region according to an example embodiment of the present disclosure.

### DETAILED DESCRIPTION OF SOME EXAMPLE EMBODIMENTS

Some embodiments will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present disclosure.

Methods, apparatus and computer program products are provided in accordance with an example embodiment in order to estimate dynamic population over a large area, and more particularly, to combining measured population data and mobility data to generate calibrated population estimation and extrapolating that calibrated population estimation across a broader area. Census data can only provide a snapshot of population information for geographical areas of a geographic region. However, dynamic population estimation for finite geographic sub-regions including temporal population shifts and movement can be useful to a variety of industries. Further, geographical areas may not correspond with geographic sub-regions. For example, a geographical area for static population data may include a zip code, a city, a county boundary, etc. A geographic sub-region may be more narrow, such as a neighborhood, or a building within a city, for example. Dynamic population estimation may be useful for identifying locations for advertising, planning mass transit (e.g, routes and stops), evaluating locations for alternative transportation clustering (e.g., ride-share vehicles, bicycle/scooter stations, etc.), identifying emergency service coverage areas and needs, residential planning, etc. According to example embodiments described herein, the wide availability of mobility data can be fused with observed population counts in selected areas to provide a calibrated corrolation between the observed population and the mobility data. Embodiments combine dynamic input data from mobility data and observed data from deployed population count sensors to estimate the dynamic population within an area.

Dynamic mobility data may be generated by an identified location of a probe which may take the form of a device that can report location. Dynamic mobility data is data that is regularly changing and is updated frequently, such as in real-time or periodically in terms of seconds, minutes, or hours, typically. An instance of mobility data generated by a probe or mobile device may include, among other information, location information/data, heading information/data, etc. For example, the probe information/data may include a geophysical location (e.g., latitude and longitude) indicating the location of the probe apparatus at the time that the probe information/data is generated and/or provided (e.g., transmitted). The probe information/data may optionally include a heading or direction of travel. In an example embodiment, an instance of probe information/data may include a probe identifier identifying the probe apparatus that generated and/or provided the probe information/data, a timestamp corresponding to when the probe information/data was generated, and/or the like. Further, based on the probe identifier and the timestamp, a sequence of instances of probe information/data may be identified. For example, the instances of probe information of data corresponding to a sequence of instances of probe information/data may each comprise the same probe identifier or an anonymized identifier indicating that the data is from the same, anonymous probe. In an example embodiment, the instances of probe information/data in a sequence of instances of probe information/data are ordered based on the timestamps associated therewith to form a path.

The gathered dynamic mobility data representative of population data, detailed further below, may be associated with geographic sub-regions of a geographic region. Associating the dynamic mobility data with a geographic sub-region may include matching a location of the gathered dynamic mobility data with the area represented by a geographic sub-region. As dynamic mobility data may have a discrete location associated with each data point, each data point may be individually available to associate with any arbitrary geographic division generated, such that a geographic sub-region boundary may be established and the dynamic mobility data within that boundary at a specific time period is associated with that geographic sub-region.

Static population data, such as census information, may be associated with a geographic area, such as a city, county, zip code, etc. as described above. The static population may be associated with the geographic area based on the location of the identified population, such as the residential addresses of a population. This geographic areas of static population data may not correspond to the geographical sub-regions of dynamic mobility data as the geographical sub-regions may be smaller and more focused.

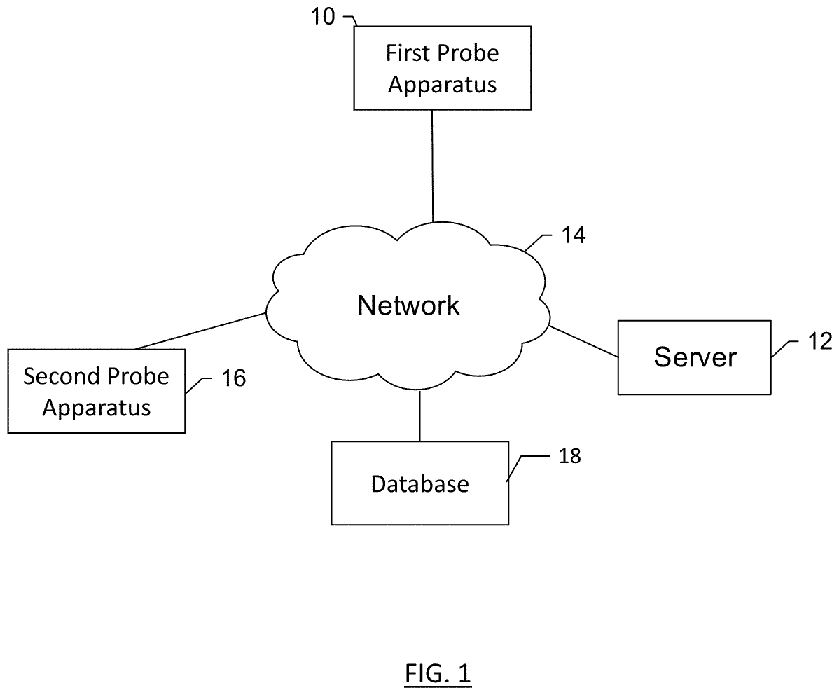

Referring now of FIG. 1, a system that supports communication, typically wirelessly, between a first probe apparatus 10, a second probe apparatus 16, a database 18, and a server 12 or other network entity (hereinafter generically referenced as a “server”) is illustrated. As shown, the probe apparatuses, database, and the server may be in communication via a network 14, such as a wide area network, such as a cellular network or the Internet or a local area network. However, the user devices and the server 12 may be in communication in other manners, such as via direct communications between a probe apparatus (e.g. probe apparatus 10 or 16) and the server 12, or direct communications between the probe apparatuses 10 and 16.

The probe apparatuses 10 and 16 may be embodied by a number of different devices including mobile computing devices, such as a personal digital assistant (PDA), mobile telephone, smartphone, laptop computer, tablet computer, vehicle navigation system, infotainment system, in-vehicle computer, or any combination of the aforementioned, and other types of voice and text communications systems. The server 12 may also be embodied by a computing device and, in one embodiment, is embodied by a web server. Additionally, while the system of FIG. 1 depicts a single server and two probe apparatuses, the system may include any number of servers and probe apparatuses, which may operate independently or collaborate to support activities of the probe apparatuses.

The database 18 may include one or more databases and may include information such as a map database in which geographic information may be stored relating to road networks, points-of-interest, buildings, etc. Further, the database may store therein static population data, such as census data relating to populations of geographical areas of a geographic region. The static population information may be provided by, for example, a municipality or governmental entity. The database may also include historical dynamic population and mobility data, such as historical traffic data, mobile device data, monitored area data (e.g., closed-circuit television), or the like. Thus, the database 18 may be used to facilitate the generation of dynamic population estimation in conjunction with the server 12 and probe apparatuses 10 and 16 through the collection of dynamic mobility data.

Static population data, as described herein, may include data that is not real-time data and is only updated on a periodic basis. For example, census data may be updated every ten years, or census estimates may be generated every year to produce static population data for geographical areas of a geographic region. Static data may include data other than census data, such as a population count of a neighborhood, building, or city that may be updated weekly, monthly, or annually, for example. Static data may be generated by a variety of means; however, static population data generally includes establishing population count based on residential addresses of the population such that the static population data does not reflect any movement of the population during a day/month/year. Static population may include population data that is updated only periodically, and less frequently than a predefined amount of time, such as weekly, monthly, yearly, or longer. Further, static population data may be generated for a geographic region and the static population data may be broken down within that region into geographical areas. These geographical areas may correspond to boundaries such as zip codes, cities, counties, or other defined boundaries, for example.

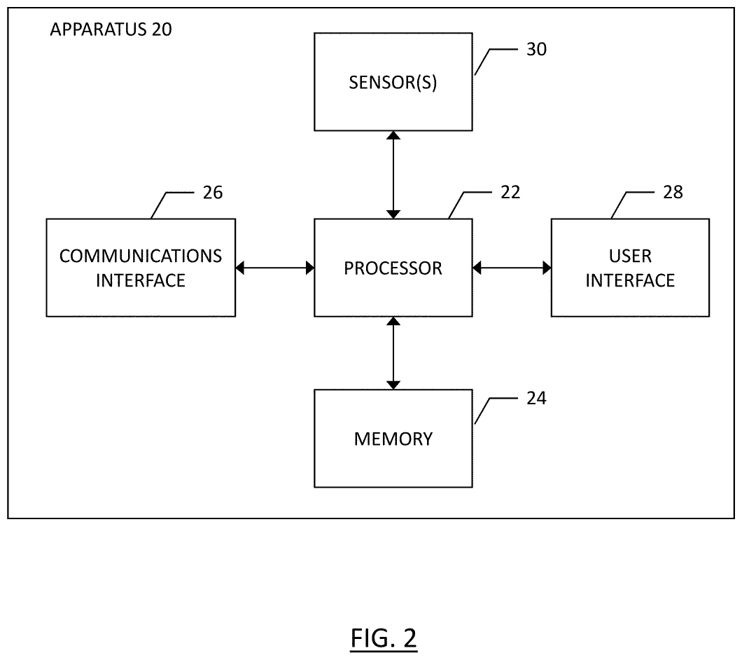

Regardless of the type of device that embodies the probe apparatuses 10 or 16, the probe apparatuses may include or be associated with an apparatus 20 as shown in FIG. 2. In this regard, the apparatus 20 may include or otherwise be in communication with a processor 22, a memory device 24, a communication interface 26 and a user interface 28. As such, in some embodiments, although devices or elements are shown as being in communication with each other, hereinafter such devices or elements should be considered to be capable of being embodied within the same device or element and thus, devices or elements shown in communication should be understood to alternatively be portions of the same device or element.

In some embodiments, the processor 22 (and/or co-processors or any other processing circuitry assisting or otherwise associated with the processor) may be in communication with the memory device 24 via a bus for passing information among components of the apparatus. The memory device 24 may include, for example, one or more volatile and/or non-volatile memories. In other words, for example, the memory device 24 may be an electronic storage device (e.g., a computer readable storage medium) comprising gates configured to store data (e.g., bits) that may be retrievable by a machine (e.g., a computing device like the processor). The memory device 24 may be configured to store information, data, content, applications, instructions, or the like for enabling the apparatus 20 to carry out various functions in accordance with an example embodiment of the present invention. For example, the memory device 24 could be configured to buffer input data for processing by the processor 22. Additionally or alternatively, the memory device could be configured to store instructions for execution by the processor.

The processor 22 may be embodied in a number of different ways. For example, the processor 22 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor 22 may include one or more processors configured in tandem via the bus to enable independent execution of instructions, pipelining and/or multithreading.

In an example embodiment, the processor 22 may be configured to execute instructions stored in the memory device 24 or otherwise accessible to the processor 22. Alternatively or additionally, the processor 22 may be configured to execute hard coded functionality. As such, whether configured by hardware or software methods, or by a combination thereof, the processor 22 may represent an entity (e.g., physically embodied in circuitry) capable of performing operations according to an embodiment of the present invention while configured accordingly. Thus, for example, when the processor 22 is embodied as an ASIC, FPGA or the like, the processor 22 may be specifically configured hardware for conducting the operations described herein. Alternatively, as another example, when the processor 22 is embodied as an executor of software instructions, the instructions may specifically configure the processor 22 to perform the algorithms and/or operations described herein when the instructions are executed. However, in some cases, the processor 22 may be a processor of a specific device (e.g., a head-mounted display) configured to employ an embodiment of the present invention by further configuration of the processor 22 by instructions for performing the algorithms and/or operations described herein. The processor 22 may include, among other things, a clock, an arithmetic logic unit (ALU) and logic gates configured to support operation of the processor 22. In one embodiment, the processor 22 may also include user interface circuitry configured to control at least some functions of one or more elements of the user interface 28.

Meanwhile, the communication interface 26 may include various components, such as a device or circuitry embodied in either hardware or a combination of hardware and software that is configured to receive and/or transmit data between a computing device (e.g. user device 10 or 16) and a server 12. In this regard, the communication interface 26 may include, for example, an antenna (or multiple antennas) and supporting hardware and/or software for enabling communications wirelessly. Additionally or alternatively, the communication interface 26 may include the circuitry for interacting with the antenna(s) to cause transmission of signals via the antenna(s) or to handle receipt of signals received via the antenna(s). For example, the communications interface 26 may be configured to communicate wirelessly with a head-mounted display, such as via Wi-Fi (e.g., vehicular Wi-Fi standard 802.11p), Bluetooth, mobile communications standards (e.g., 3G, 4G, or 5G) or other wireless communications techniques. In some instances, the communication interface 26 may alternatively or also support wired communication. As such, for example, the communication interface 26 may include a communication modem and/or other hardware/software for supporting communication via cable, digital subscriber line (DSL), universal serial bus (USB) or other mechanisms. For example, the communication interface 26 may be configured to communicate via wired communication with other components of a computing device.

The user interface 28 may be in communication with the processor 22, such as the user interface circuitry, to receive an indication of a user input and/or to provide an audible, visual, mechanical, or other output to a user. As such, the user interface 28 may include, for example, a keyboard, a mouse, a joystick, a display, a touch screen display, a microphone, a speaker, and/or other input/output mechanisms. In some embodiments, a display may refer to display on a screen, on a wall, on glasses (e.g., near-eye-display), in the air, etc. The user interface 28 may also be in communication with the memory 24 and/or the communication interface 26, such as via a bus.

The communication interface 26 may facilitate communication between different user devices and/or between the server 12 and user devices 10 or 16. The communications interface 26 may be capable of operating in accordance with various first generation (1G), second generation (2G), 2.5G, third-generation (3G) communication protocols, fourth-generation (4G) communication protocols, Internet Protocol Multimedia Subsystem (IMS) communication protocols (e.g., session initiation protocol (SIP)), and/or the like. For example, a mobile terminal may be capable of operating in accordance with 2G wireless communication protocols IS-136 (Time Division Multiple Access (TDMA)), Global System for Mobile communications (GSM), IS-95 (Code Division Multiple Access (CDMA)), and/or the like. Also, for example, the mobile terminal may be capable of operating in accordance with 2.5G wireless communication protocols General Packet Radio Service (GPRS), Enhanced Data GSM Environment (EDGE), and/or the like. Further, for example, the mobile terminal may be capable of operating in accordance with 3G wireless communication protocols such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The mobile terminal may be additionally capable of operating in accordance with 3.9G wireless communication protocols such as Long Term Evolution (LTE) or Evolved Universal Terrestrial Radio Access Network (E-UTRAN) and/or the like. Additionally, for example, the mobile terminal may be capable of operating in accordance with fourth-generation (4G) wireless communication protocols and/or the like as well as similar wireless communication protocols that may be developed in the future.

The apparatus 20 of example embodiments may further include one or more sensors 30 which may include location sensors, for example a global navigation satellite system (GNSS) sensor such as global positioning system (GPS) sensors, GALILEO, BeiDou, GLONASS, or the like, sensors to detect wireless signals for wireless signal fingerprinting, sensors to identify an environment of the apparatus 20 such as image sensors for identifying a location of the apparatus 20, or any variety of sensors which may provide the apparatus 20 with an indication of location.

While the apparatus 20 is shown and described to correspond to a probe apparatus, embodiments provided herein may include a user device that may be used for a practical implementation of embodiments of the present disclosure. For example, such an apparatus may include a laptop computer, desktop computer, tablet computer, mobile phone, or the like. Each of which may be capable of providing a graphical user interface (e.g., presented via display or user interface 28) to a user for interaction with a map providing dynamic population estimates for geographic sub-regions within a map as described further below. Embodiments of the user device may include components similar to those as shown in FIG. 2 through which a user may interact with dynamic population and mobility data presented on the display of a user interface for a device, such as apparatus 20.

Embodiments described herein relate to estimating dynamic population over a large area, and more particularly, to using measured population data and mobility data to generate calibrated population estimations for which measured population data is not available. Embodiments employ measured population data, representing a visual, confirmed count of a population through the use of various types of sensors for limited areas in combination with dynamic mobility data for those limited areas to augment dynamic mobility data for areas in which measured population data is not available. To augment dynamic mobility data in areas in which measured population data is not, a sampling rate is generated from areas in which measured population data is available to supplement dynamic mobility data in the same area. The sampling rate is used to augment the dynamic mobility data in areas in which measured population data is not available. Further, sampling rates may be classified by context, whereby for an area lacking measured population data, a sampling rate may be used to augment dynamic mobility data from that area where the sampling rate is associated with a context within a predefined similarity to a context of the area.

By augmenting available dynamic mobility data with identified sampling rates, dynamic population estimates for an area lacking measured population data can be accurately produced. The results of such estimations may be provided in a visual representation on a user interface and made user-friendly through a service that provides dynamic population estimation for consumption by various industries and applications that may benefit from dynamic population estimation using a probability that a predetermined number of people will be observed in an area.

A geographic region may be divided into geographic sub-areas or sub-regions. These sub-regions may be defined by geographic boundaries, municipal boundaries, or any manner of sub-dividing a geographic region. One example of sub-division of a geographic region may include the application of a grid to the region. The grid may include square or rectangular cells; however, hexagonal cells may provide greater flexibility for the use of the grid of geographic sub-regions as each cell would have six available neighboring cells for use cases where a population estimation is used for avoiding heavily populated, and potentially heavily trafficked areas. Geographic sub-regions arranged in hexagonal cells may aid in finding smoother paths from cell to cell while offering complete coverage of a geographic region. Dynamic population estimation may be made per individual cell, while larger areas can be handled by adding the contents of adjoining cells within the larger area.

Static population data may be received from sources such as a census bureau, local, regional, or national governmental entities, or private population data collection/estimation services. This static population data may be indicative of a primary location of individuals of a population, such as their residential address. This data, while useful, does not provide sufficient detail with regard to the fluidity of the movement of people throughout a day, week, month, season, or year, for example.

Dynamic mobility data may be gathered through various sources. For example, probe data from probes 20 may be collected from user's mobile devices such as cell phones which can report location and movement of a user. This data may be real-time probe data or historical probe data from users. Other probes such as probes associated with vehicles may provide traffic data, which may also be real-time or historical traffic data. Historical traffic data can be considered dynamic mobility data indicative of the population of an area as it tracks the ebb and flow of a population as it moves over short periods of time and for specific time instances. Thus, it is not static population data identifying a static, unchanging location of a person. Probe data provides accurate location through locationing mechanisms employed by the probes, which may include, for example, a global navigation satellite system (GNSS) sensor such as global positioning system (GPS) sensors, GALILEO, BeiDou, GLONASS, or the like, wireless fingerprinting, access point identifiers, etc. Other dynamic mobility data indicative of a population of an area may be collected through social media, such as through user check-ins at locations, users self-identifying locations or enabling location access within social media, attendance at events identified within social media, or the like.

Measured population data, which measures the population based on a count of physically present people in an area, may be provided by devices and sensors monitoring specific locations, such as closed-circuit television cameras or security cameras that capture individuals in the field of view and may recognize individual people through image recognition software to provide a count of population in a field of view or a count of population passing through a field of view, such as in a particular direction to capture movement of the population toward or away from a location. Measured population data may also be established by cameras on roadways such as at toll points along a roadway, along a road segment, or at an intersection. Other devices may be used to identify measured population data such as thermal imaging cameras, infrared sensors, computer vision and object detection, stereoscopic imaging, etc. These sensors to measure population data through a headcount or people-count process may be stationary, such as installed along streets, sidewalks, building entrances, etc., or may be dynamic, such as carried by an aerial vehicle or mounted to a terrestrial vehicle such as a car. Measured population data can provide accurate and absolute population data; however, it is expensive to deploy and maintain over a large area, such as would be required to measure the dynamic population at a high level of spatiotemporal resolution in a large spatial area (e.g., the hourly population of a one-kilometer grid of a state or country).

Conversely, dynamic mobility data can be collected from a variety of devices, as described above, such as mobile devices (e.g., phones), personal navigation devices, etc. These mobile probes provide a much larger spatial coverage in a cost-efficient way because no new infrastructure is needed to support the collection of dynamic mobility data. However, dynamic mobility counts themselves are not a complete observation of the whole population as generally only a small fraction of people are observed through mobility data at any place and time. Further, the sampling rate changes with time and space.

Embodiments provided herein combine the measured population data from a finite number of counting sensors covering select areas and dynamic mobility data for those select areas to generate an accurate estimate of the dynamic population using dynamic mobility data of an area not having measured population data.

Using dynamic mobility data, in combination with measured population data, to generate a population estimate within a geographic sub-region at any given time may have an accuracy and quality defined by the frequency with which the dynamic mobility data is updated. For example, dynamic mobility data updated every hour may not provide sufficient granularity to generate an accurate estimate of the population within a geographic sub-region in fifteen minute increments. Increasing the frequency of update of the dynamic mobility data may increase the accuracy of the population estimates and allow the analysis and review of population data within finer epochs. However, the frequency of dynamic mobility data updates may be balanced with bandwidth, storage capacity, processing capacity, or the like against the benefits of more frequently updated data.

While dynamic population data may provide a robust indicator of the presence of people, dynamic population data may also provide too much data and may result in individuals being counted multiple times by different devices, such as a user traveling in a vehicle functioning as a probe while also carrying a mobile device functioning as a probe.

The fusion of measured population data and dynamic mobility data as described in example embodiments may provide a robust and reliable estimate of a population of a finite geographical region or sub-region. Further, embodiments provided herein may include a graphical user interface available for user analysis and manipulation to deep-dive population numbers for finite geographic areas. The population estimates may be used by service providers to enhance a variety of different types of services. For example, dynamic advertising may be used to reach the greatest number of people. Whether by digital screens (e.g., billboard) or by electronic notification messages, advertisers can better find an audience using dynamic population estimations. Further, advertising rates may be adjusted based on the dynamic population of an area, with higher population areas commanding higher rates for advertising. Individual stores or market segments may target a population within a predetermined distance of a store. For example, if dynamic population estimates indicate a relatively higher number of people proximate a particular store, the store may provide digital messaging or notifications to the population proximate the store to solicit business.

Service providers such as traffic service providers may use dynamic population data to identify areas of heavy vehicle traffic. Recipients of the service may be users of autonomous vehicle or users of a navigational service, where in either case an indication of heavy traffic may be provided to aid the user in avoiding areas of heavy traffic. Service providers that may use embodiments of the present disclosure may further include emergency service providers that can identify areas in which emergency services may be more likely to be needed, such that emergency service staff and equipment can be deployed to facilitate faster response. Dynamic population data may also be used to indicate to an individual, either through access to the dynamic population data or a service provider that an area they wish to visit is either busy or not busy with other people, thereby helping the user plan a visit to the area. Identifying the dynamic population of an area has a wide variety of uses that can be explored to enhance services provided to users and to provide valuable information to consumers.

Dynamic mobility data from dynamic data or probe sources may be able to capture movement of persons from one area to another; however, probe data from dynamic data sources may be anonymized to preclude this depending on national or regional laws relating to data privacy, or due to user preferences with regard to data sharing. Probe data from dynamic data sources is not configured to be able to identify individuals; however, probe data may include random identifiers to identify data source which may enable differentiation between different data source types.

Embodiments of the present disclosure may employ a geospatial partition scheme to segment a geographic region into smaller sub-areas or sub-regions. Arbitrary geometric boundaries, a city, or a particular spatial area may be partitioned into sub-areas or sub-regions. The dynamic population may be estimated for a given geographic sub-region may be dynamic in that it changes over time. The dynamic population estimate for a given area may not only be broken down by geographic segments and sub-regions, but segmented temporally. A temporal partition scheme may be used, such as fifteen minute or one-hour time bins, for example. Embodiments provided herein establish dynamic population estimates to estimate the number of people in a plurality of sub-regions across some or all time instants or epochs.

To this end, dynamic mobility data may be gathered by a dynamic mobility data provider 120 or service for a geographic region from traffic data 102, mobile operator (e.g., cell phone service provider) data 104, GNSS device data 106, social media check-ins 108, and dynamic data source 110. Each of these dynamic data sources provides data to a service that may model population estimates for an area in which the data was gathered.

Dynamic mobility data may not be representative of a number of people in a given geographic sub-region. For example, a vehicle may include more than one person, and a person may be identified by multiple devices (e.g., mobile phone, vehicle, social media check-ins, etc.). Embodiments of a dynamic mobility data provider may collect dynamic mobility data and disambiguate the data to estimate a population count relative to mobility data. However, as noted above, dynamic mobility data is only an approximation of a population. Embodiments described herein use measured population data for select geographic sub-regions in combination with dynamic mobility data for those sub-regions to provide a more accurate population estimate for the respective sub-region. Further, the determination of the more accurate population estimate is used to augment the dynamic mobility data at geographic sub-regions where measured population data is not available to provide a more accurate population estimate at those sub-regions not available through the use of dynamic mobility data alone.

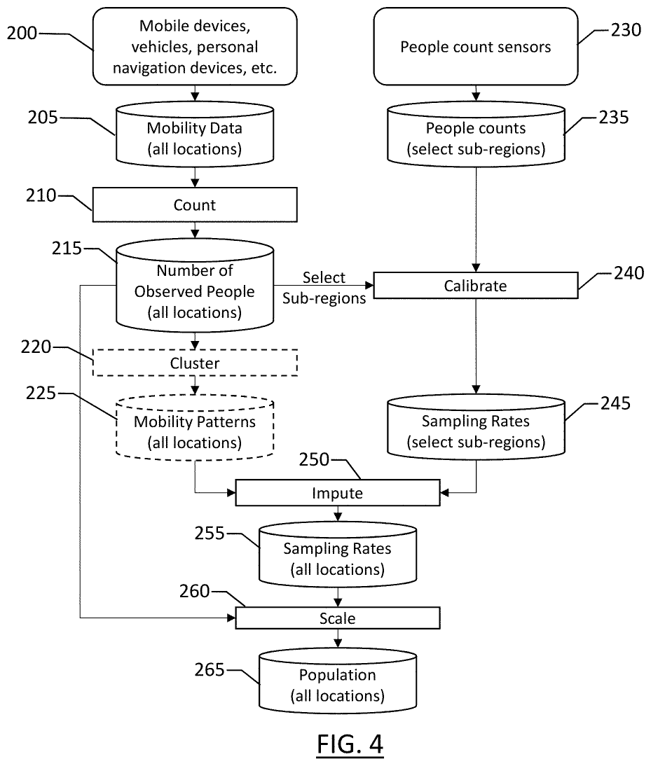

FIG. 4 illustrates a flowchart of operations for population estimation across all sub-regions of a geographic region, regardless of the availability of measured population data. As shown, dynamic mobility data is collected from devices at 200 and stored at 205. The dynamic mobility data for each sub-region of a geographic region may be collected over all time instants and binned according to geographic sub-region and epoch for storage at 205. The mobility data is disambiguated and counted at 210, such that a number of people observed based on the dynamic mobility data is stored at 215 for all sub-regions of a geographic region.

Measured population data is identified at 230 from sensors to count individual people, and the measured population data is stored at 235 for each time epoch for select sub-regions of the geographic region that are equipped with the infrastructure to perform the population data measurement of individual people. The number of observed people from the dynamic mobility data at 215 for the select sub-regions and time epochs is provided to the calibration operation 240 together with the measured population data in the form of people counts in the time epochs from the select sub-regions from 235. Using the dynamic mobility data for these sub-regions and the measured population data for the same sub-regions at each time epoch, a sampling rate is determined through calibration at 240. The calibration establishes, for each sub-region and time epoch, a sampling rate. The equation below illustrates this sampling rate calculated for each geographic sub-region s and at each time epoch t:

$$sampling rate ( s , t ) = \frac{dynamic mobility data observed people ( s , t ) }{measured population ( s , t )}$$

Calibration may also consider historical sampling rates from different time epochs to influence the sampling rate.

For example, the sampling rate may be weighted based on historical data. If a sampling rate for a sub-region of a beach vacation destination on Saturday mornings in the summer are collected for a predetermined time window (e.g. the 10:00 am-10:15 am time epoch) are established over a number of summer Saturday mornings, a subsequent sampling rate may be factored in to the existing sampling rate for that time epoch. Such averaging over time epochs of a similar context—the context being the time, the season, and the location in this instance—a single Saturday morning that is raining and has a skewed sampling rate may not dramatically affect the typical sampling rate of a sunny Saturday morning at the beach sub-region. A sampling rate predicted for a subsequent sunny summer Saturday morning may thus be less influenced by the skewed sampling rate of a rainy day. Further, the context may optionally include weather, such that the sampling rate for the rainy Saturday morning may not be considered for sunny days, while if another rainy Saturday summer morning occurs, the prior sampling rate for a similar rainy Saturday summer morning may be used for predictive purposes.

While historical data may be considered in establishing a sampling rate, embodiments described herein may employ real-time or near real-time population estimation through the process described in the flowchart of FIG. 4. The real-time or near real-time population estimation may be population estimation for a previous time period, updated periodically such as every five minutes, for example. Thus, embodiments may be used for predictive population estimation or substantially real-time population estimation.

Referring back to FIG. 4, the sampling rates established at calibration 240 are stored at 245 for the respective sub-regions for which measured population data was available. As measured population data is not available for all sub-regions, and generally would not be available for most sub-regions, the sampling rates for the select sub-regions may be used to augment the dynamic mobility data of those other locations to provide a more accurate population estimation, despite the absence of measured population data.

Operation 220 performs a clustering operation on the dynamic mobility data identifying a number of observed people at each sub-region of a geographic region. While clustering is illustrated in the flowchart of FIG. 4 as occurring prior to imputation operation 250, clustering may be part of the imputation as described herein, such that the cluster operation 220 shown is optional. Clustering may identify sub-regions of the geographic region having a context within a predetermined similarity of one another. For example, if context includes a time of day, day of week, weather, and season, context similarity may be established as matching three of those four parameters, or matching three of those four parameters within a predetermined degree (e.g., within 30 minutes of the time, within 15 degrees farenheit of the weather, etc.). Context may optionally include geographic features of a sub-region, such as if the sub-region includes public transit stops, points-of-interest types/categories (e.g., restaurants, theaters, sports venues, retail stores, etc.). A context of geographic features may be established based on data in the map database 18. Further, context may include the type of zoning for an area, such as residential, commercial, agricultural, or industrial, for example, which may also come from the map database 18. A restaurant district in one sub-region may have similar dynamic mobility data as another sub-region that includes a restaurant district, such that these two sub-regions may be considered contextually similar. Similarly, a sub-region that is identified as zoned residential may have similar dynamic mobility data to another sub-region that is zoned residential. Thus, the context similarity may be established based on a degree of similarity between the parameters of the context. Further, the context may include any number of distinguishing parameters, and the predefined similarity may be based on a number of correspondences between contextual parameters of the context.

Clustering, according to some embodiments, may optionally not consider context and may only consider time and location, or location and dynamic mobility count of observed people, for example. However, clustering is performed, the purpose of the clustering is to associate different geographic sub-regions and epochs with one another for efficiency. These clusters of sub-regions with similar properties may be stored at 225. However, as noted above, this is optional and may also be performed during imputation 250.

The imputation operation 250 correlates select sub-regions—those having measured population data—with sub-regions (or clusters of those sub-regions identified in 220) lacking measured population data. Once correlated, the sampling rate from a select sub-region having measured population data is used as the sampling rate for a correlated sub-location lacking measured population data. This correlation may be performed on clustered sub-regions as described above, or the correlation may be independent of clustering, such that a select sub-region is correlated with each of the other sub-regions to identify contextually similar sub-regions or sub-regions having similar properties. Once a sub-region lacking population measurement data is associated with a sampling rate, the sampling rate is stored for that sub-region at 255.

The sampling rate of a sub-region is scaled at 260 to provide an accurate population count for the sub-region. The scaling is determine by dividing the number of people observed through the dynamic mobility data at a given sub-region from 215, by the sampling rate correlated with that sub-region from 255. The sub-region may be a select sub-region from which the sampling rate was established, or the sub-region may be another sub-region that lacked measured population data but had a sampling rate correlated to that sub-region. In either case, the population estimate for that sub-region is calculated as:

$$population estimation ( s , t ) = \frac{dynamic mobility data observed people ( s , t ) }{sampling population ( s , t )}$$

This equation calculates the population estimation from current dynamic mobility data observed people and the sampling rate. This population estimation can be combined with previous dynamic mobility data observed people and sampling rate from a prior epoch to enhance the population estimation. The historic population estimation may be used together with a current population estimation when the historic population estimation comes from a similar epoch, or a similar context. For example, a historic population estimation from a prior Saturday afternoon of a similar season with similar weather may inform the current population estimation for a current Saturday afternoon.

Using the technique described above, a population estimation may be generated to estimate a population within a geographic sub-region. This population estimation may be used to determine a population density estimate and can be visualized as a discrete heatmap using the sub-regions which may, for example, be hexagonal cells as described above. The visualization of some example embodiments may be based on hexagonal partitions of the geographical area into hexagonal sub-regions. These hexagonal cells representing the sub-regions provide smoother paths from cell to cell while offering complete coverage. In this way, adjacent cells always share an edge, rather than a square grid in which a path from one cell to another may be through a vertex diagonally between cells that do not share an edge. However, any type of regular geographical partition could be used and serve as a basis for the calculation of population estimates. Further, calculations for irregular geographical partitions could be performed by aggregating the results of finer, regular geometric partitions.

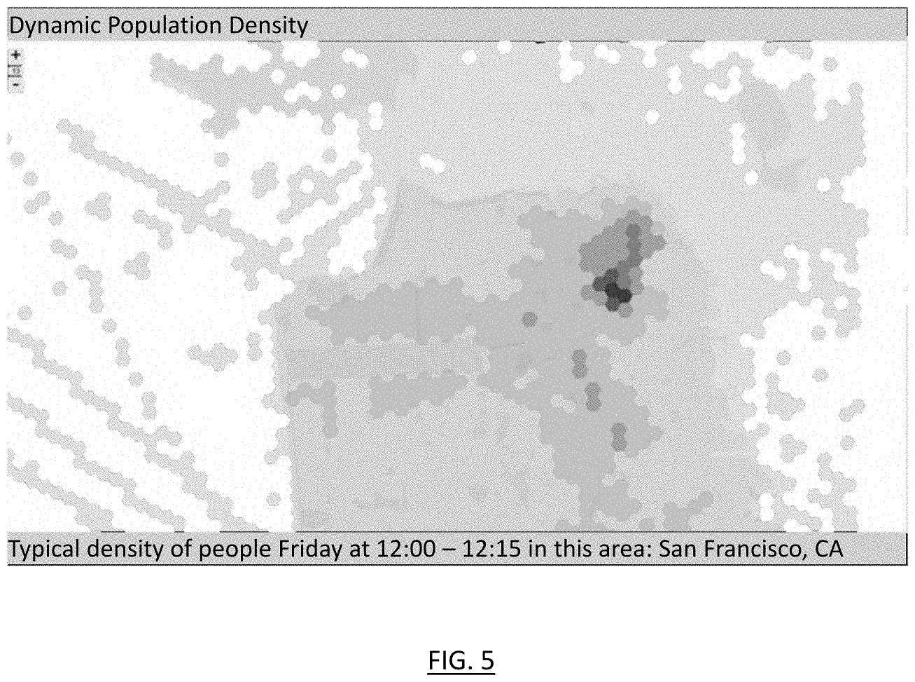

FIG. 5 illustrates an example embodiment of a heat map illustrating dynamic population density displayed for a plurality of hexagonal sub-regions, with the darker shades representing higher population density. As shown, the heat map is not only for population estimates of each of the geographic sub-regions, but also for a time period or epoch, which in the illustrated embodiment is “Friday at 12:00-12:15”. Such a time could represent the daytime population of a region where many people are at work rather than at home, such that the population may concentrate in a business district or industrial area, while suburbs and residential areas may be less populated than would be suggested by static census data. Conversely, a dynamic population estimate at 4:00 am-5:00 am may more closely align with static census population data as the majority of people will be at their residential address.

Embodiments described herein may be useful for a wide variety of practical implementations, such as for establishing where people are at a given time, or how people move throughout a day. Such information may be beneficial to advertisers so they understand where to target specific advertisements and at what times to do so. Other use cases may include aviation where a city may be sensitive to the noise generated by aircraft approaching and departing an airport due to noise issues. Embodiments may provide an indication of preferred flight paths where flight paths are more desirable to be over less-dense areas. Census data may suggest that populations are static in residential areas. However, embodiments described herein may demonstrate that it is undesirable to fly over businesses or industrial areas during the day, and instead to fly over residential areas of lower population to disrupt the fewest number of people. Embodiments may also be used to plan for emergency services and staffing such that emergency services proximate low population areas at certain times of the day may require lower staffing levels than during times of day in which those same areas have a high population.

Example embodiments provided herein may provide population estimates within one or more geographic sub-regions at specific times, and may present this information on graphical user interfaces as described above with respect to FIG. 5. The population estimates and predictions may also be queried live by third party systems that support the example use cases described above by an application programming interface such that the population estimates and predictions may be provided to third party systems without necessarily implementing the graphical user interfaces shown.

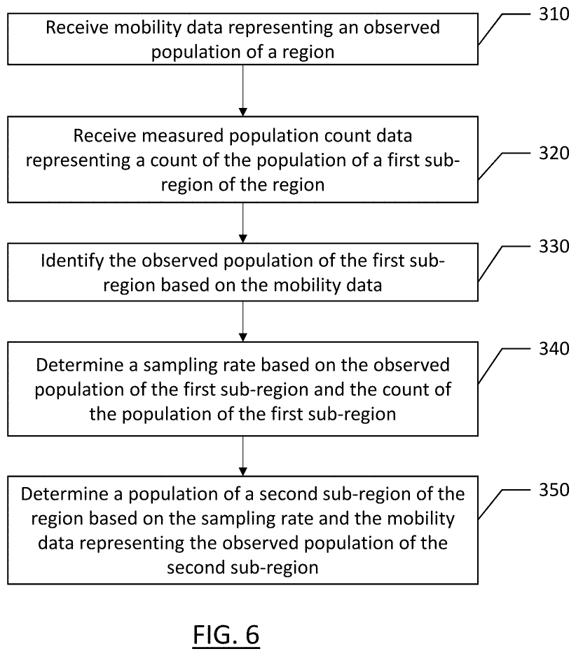

FIG. 6 illustrates a flowchart of a method for estimating dynamic population over a large area, and more particularly, to using measured population data and mobility data to generate calibrated population estimations for which measured population data is not available. As shown, mobility data is received at 310 representing an observed population of a region. Mobility data may be received, for example, from mobile devices within the region. Population count data representing a count of a first sub-region of the region is received at 320. This data may be received, for example, from a sensor arranged to visually confirm and count the physical presence of people within the first sub-region. The observed population of the first sub-region is identified at 330 based on the mobility data within the first sub-regions. A sampling rate is determined at 340 based on the observed population of the first sub-region and the count of the population of the first sub-region. A population of a second sub-region is determined at 350 based on the sampling rate and the mobility data representing the observed population of the second sub-region.

As described above, FIG. 6 illustrates a flowchart of apparatuses 20, methods, and computer program products according to an example embodiment of the disclosure. It will be understood that each block of the flowchart, and combinations of blocks in the flowchart, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by the memory device 24 of an apparatus employing an embodiment of the present invention and executed by the processor 22 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In an example embodiment, an apparatus for performing the method of FIG. 6 above may comprise a processor (e.g., the processor 22) configured to perform some or each of the operations (310-350) described above. The processor may, for example, be configured to perform the operations (310-350) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 310-350 may comprise, for example, the processor 22 and/or a device or circuit for executing instructions or executing an algorithm for processing information as described above.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. An apparatus comprising at least one processor and at least one memory including computer program code, the at least one memory and the computer program code configured to, with the processor, cause the apparatus to at least:
receive mobility data representing an observed population of a region;
receive measured population count data representing a count of the population of a first sub-region of the region, wherein the population count data is generated based on at least one sensor arranged to visually confirm and count the physical presence of people within the first sub-region;
identify the observed population of the first sub-region from the mobility data;
determine a sampling rate based upon the observed population of the first sub-region and the count of the population of the first sub-region; and
determine a population of a second sub-region of the region based on the sampling rate and mobility data representing the observed population of the second sub-region.

2. The apparatus of claim 1, wherein the mobility data comprises location information for a plurality of mobile devices within the region.

3. The apparatus of claim 1, wherein the sampling rate is established for a first epoch based on a time and context of the mobility data and the population count data, and wherein causing the apparatus to calculate the population of the second sub-region of the region based on the sampling rate and the mobility data representing the observed population of the second sub-region comprises causing the apparatus to:
calculate the population of the second sub-region of the region for a second epoch based on the sampling rate and mobility data representing the observed population of the second sub-region for a time and context within a predefined similarity of the first epoch.

4. The apparatus of claim 3, wherein the context comprises context elements, wherein the context elements of a context comprise at least one of: a season, a day of week, a month of year, a weather condition, a point-of-interest type, and a type of zoning, wherein a predefined similarity of context comprises correspondence of at least one context element between the first sub-region and the second sub-region.

5. The apparatus of claim 1, wherein the apparatus is further caused to:
divide observed populations of each of a first plurality of sub-regions by a count of the population of a respective sub-region of the first plurality of sub-regions to obtain a sampling rate for each of the first plurality of sub-regions;
identify observed populations of a second plurality of sub-regions; and
calculate a population of at least one of the second plurality of sub-regions based on the observed population of the at least one of the second plurality of sub-regions and a sampling rate from a sub-region of the first plurality of sub-regions having an observed population within a predetermined degree of similarity of the at least one of the second plurality of sub-regions.

6. The apparatus of claim 1, wherein the apparatus is further configured to:
provide the population of the second sub-region to a service provider, wherein the service provider provides a service within the second sub-region based, at least in part, on the population of the second sub-region.

7. The apparatus of claim 1, wherein the apparatus is further configured to:
provide the population of the second sub-region to a service provider, wherein the service provider provides a service within the second sub-region having a cost based, at least in part, on the population of the second sub-region.

8. A computer program product comprising at least one non-transitory computer-readable storage medium having computer-executable program code instructions stored therein, the computer-executable program code instructions comprising program code instructions to:
receive mobility data representing an observed population of a region;
receive population count data representing a count of the population of a first sub-region of the region, wherein the population count data is generated based on at least one sensor arranged to visually confirm and count the physical presence of people within the first sub-region;
identify the observed population of the first sub-region from the mobility data;
determine a sampling rate based upon the observed population of the first sub-region and the count of the population of the first sub-region; and
determine a population of a second sub-region of the region based on the sampling rate and mobility data representing the observed population of the second sub-region.

9. The computer program product of claim 8, wherein the mobility data comprises location information for a plurality of mobile devices within the region.

10. The computer program product of claim 8, wherein the sampling rate is established for a first epoch based on a time and context of the mobility data and the population count data, and wherein the program code instructions to calculate the population of the second sub-region of the region based on the sampling rate and the mobility data representing the observed population of the second sub-region comprise program code instructions to:
calculate the population of the second sub-region of the region for a second epoch based on the sampling rate and mobility data representing the observed population of the second sub-region for a time and context within a predefined similarity of the first epoch.

11. The computer program product of claim 10, wherein the context comprises context elements, wherein the context elements of a context comprise at least one of: a season, a day of week, a month of year, a weather condition, a point-of-interest type, and a type of zoning, wherein a predefined similarity of context comprises correspondence of at least one context element between the first sub-region and the second sub-region.

12. The computer program product of claim 8, further comprising program code instructions to:
divide observed populations of each of a first plurality of sub-regions by a count of the population of a respective sub-region of the first plurality of sub-regions to obtain a sampling rate for each of the first plurality of sub-regions;
identify observed populations of a second plurality of sub-regions; and
calculate a population of at least one of the second plurality of sub-regions based on the observed population of the at least one of the second plurality of sub-regions and a sampling rate from a sub-region of the first plurality of sub-regions having an observed population within a predetermined degree of similarity of the at least one of the second plurality of sub-regions.

13. The computer program product of claim 8, further comprising program code instructions to:
provide the population of the second sub-region to a service provider, wherein the service provider provides a service within the second sub-region based, at least in part, on the population of the second sub-region.

14. The computer program product of claim 8, further comprising program code instructions to:
provide the population of the second sub-region to a service provider, wherein the service provider provides a service within the second sub-region having a cost based, at least in part, on the population of the second sub-region.

15. A method comprising:
receiving mobility data representing an observed population of a region;
receiving population count data representing a count of the population of a first sub-region of the region, wherein the population count data is generated based on at least one sensor arranged to visually confirm and count the physical presence of people within the first sub-region;
identifying the observed population of the first sub-region from the mobility data;
determining a sampling rate based upon the observed population of the first sub-region and the count of the population of the first sub-region; and
determining a population of a second sub-region of the region based on the sampling rate and mobility data representing the observed population of the second sub-region.

16. The method of claim 15, wherein the mobility data comprises location information for a plurality of mobile devices within the region.

17. The method of claim 15, wherein the sampling rate is established for a first epoch based on a time and context of the mobility data and the population count data, and wherein calculating the population of the second sub-region of the region based on the sampling rate and the mobility data representing the observed population of the second sub-region comprises:
calculating the population of the second sub-region of the region for a second epoch based on the sampling rate and mobility data representing the observed population of the second sub-region for a time and context within a predefined similarity of the first epoch.

18. The method of claim 17, wherein the context comprises context elements, wherein the context elements of a context comprise at least one of: a season, a day of week, a month of year, a weather condition, a point-of-interest type, and a type of zoning, wherein a predefined similarity of context comprises correspondence of at least one context element between the first sub-region and the second sub-region.

19. The method of claim 15, further comprising:
dividing observed populations of each of a first plurality of sub-regions by a count of the population of a respective sub-region of the first plurality of sub-regions to obtain a sampling rate for each of the first plurality of sub-regions;
identifying observed populations of a second plurality of sub-regions; and
calculating a population of at least one of the second plurality of sub-regions based on the observed population of the at least one of the second plurality of sub-regions and a sampling rate from a sub-region of the first plurality of sub-regions having an observed population within a predetermined degree of similarity of the at least one of the second plurality of sub-regions.

20. The method of claim 15, further comprising:
providing the population of the second sub-region to a service provider, wherein the service provider provides a service within the second sub-region based, at least in part, on the population of the second sub-region.
